(19) United States
(12) Patent Application Publication
(10) Pub. No.: US 2017/0282507 A1
(43) Pub. Date: Oct. 5, 2017

(54) BIAXIALLY ORIENTED POLYOLEFIN FILM WITH HIGH MOISTURE VAPOR BARRIER AND STIFFNESS PROPERTIES

(71) Applicant: TORAY PLASTICS (AMERICA), INC., N. Kingstown, RI (US)

(72) Inventors: Shichen DOU, Providence, RI (US); Keunsuk P. CHANG, North Kingstown, RI (US)

(73) Assignee: TORAY PLASTICS (AMERICA), INC., N. Kingstown, RI (US)

(21) Appl. No.: 15/087,525

(22) Filed: Mar. 31, 2016

(51) Int. Cl. B32B 27/08; B32B 27/32; B29C 47/92; B29C 55/12; B29C 47/00; B29C 47/06

(52) U.S. Cl. CPC B32B 27/08; B29C 47/0004; B29C 47/0057; B29C 47/065; B29C 47/92; B29C 55/12; B32B 27/325; B32B 27/32; B29L 2009/00

(57) ABSTRACT

Described are coextruded multi-layer biaxially oriented polyolefin barrier films with improved processability, moisture vapor barrier, and stiffness. The disclosed films comprise a cyclic olefin copolymer (COC) core layer blended with hydrogenated hydrocarbon resin and at least one outer layer having functionality for solvent resistance, heat sealing, or winding, or printing/coatings or adhesion for lamination.

### FIELD OF THE INVENTION

This invention relates to a multi-layer biaxially oriented polyolefin film which exhibits improved processability, moisture vapor barrier, and stiffness. More particularly, this invention relates to a multi-layer biaxially oriented polyolefin film comprising a cyclic olefin copolymer (COC) core layer blended with hydrogenated hydrocarbon resins; a first outer layer capable of solvent resistance, heat sealing, winding, adhesion, or printing; and a second outer layer capable of coating polar polymer compositions through inline or offline coating processes.

### BACKGROUND OF THE INVENTION

Polychlorotrifluoroethene (PCTFE) films are widely used in pharmaceutical, medical, sensitive electronics, and military packaging thanks to their outstanding performance in moisture vapor barrier, chemical resistance, and thermoformability. They have set the standard for clear, high moisture vapor barrier films. However, this impressive performance comes at a very significant economic cost. PCTFE films are restricted to use only in specialty packaging since both fluoropolymers and capital equipment for making fluoropolymer films are very expensive. In addition, fluoropolymer films during incineration generate hydrogen fluoride (HF) which is an environmentally hazardous by-product. Accordingly, there is a need to develop a cost-effective film product for replacement.

Cyclic olefin copolymer (COC) films have the lowest moisture vapor transmission rate (MVTR) among polyolefin films. COC films (sheets) provide a thermoformable alternative to PCTFE films. Although their moisture vapor barrier capability is not as good as that of PCTFE films, the moisture vapor barrier of a package can be improved though raising the COC film thickness. The cost of COC films is much less than that of PCTFE films. In addition, COC films thermoform at relatively low temperatures and have rapid cycle times, making them very attractive for clear forming applications requiring a moderate moisture vapor barrier, for instance, blister packaging application. In non-thermoforming applications, such as pouches and bags, COC blended into polyethylene polymers can dramatically increase film stiffness and improve the moisture barrier without affecting clarity and oxygen permeation. Oriented amorphous COC-comprising films are usually used as shrink films, while non-oriented or lightly oriented films are usually used as thermoforming films.

U.S. Pat. No. 5,534,606 describes a method of making an oriented rigid cyclic olefin copolymer film. The stretching of the film can be conducted in a temperature range of Tg-40° C.≦Tg≦Tg+50° C. through simultaneous or sequential orientation and the stretch ratios of a cyclic olefin copolymer with a specific microstructure in the machine direction and in the transverse direction are 1.5:1 to 4:1. The rigid COC films can be used in capacitor electronics, thermoformed materials, and packaging materials.

U.S. Pat. No. 5,552,504 describes the disadvantage of the low solvent resistance of amorphous cyclic olefin polymer films such as resistance to aprotic and nonpolar solvents. The disadvantage of low solvent resistance constrains the applications of amorphous cyclic olefin polymer films. This patent provided a method of making semi-crystalline cyclic olefin copolymer (ethylene norbornene copolymer) films to improve the chemical resistance and dimensional stability. However, the modification in the structure of cyclic olefin copolymer may have significantly reduced the performance of amorphous cyclic olefin copolymers in processing and moisture vapor barrier.

U.S. Pat. No. 5,583,192 describes a method of producing flexible cyclic olefin copolymer films. The flexible COC films having a high flexibility were produced by orienting a COC polymer which has a specific internal microstructure and a secondary softening below its glass transition temperature (Tg). The film has a mechanical loss factor (tan δ) of ≧0.015 at 50° C. The stretching was conducted in a Bruckner stretcher at 180° C. by a factor of 1.8 to 3.1 longitudinally and transversely. The flexible film can find applications in electronic packaging, capacitor films, display windows, and LED cells. The mechanical properties are improved by monoaxial or biaxial orientation of the films. However, as the Tg of ethylene-norbornene copolymer increases with the content of norbornene monomer, it is difficult to generate internal microstructures as the ethylene content is low in the COC copolymer.

International Patent Application WO 97/47467 describes the use of cyclic olefin copolymer (COC) films as a moisture barrier protective layer for polarizer films. A COC film (20.32 μm) was obtained by biaxial orientation having a low moisture vapor transmission rate (MVTR) of 0.38 g/100 in²/day under the test conditions of 38° C./100% RH. The COC protective film was laminated onto a polarizing layer (dyed PVOH: COTBPR) and then subjected to environmental test. The peel strength of the COC laminated film stayed almost constant while the peel strength of CTA (triacetyl cellulose) laminated film dropped off quickly with progression of time.

US Patent Publication 2007/0211334A1 describes the application of a coextruded trilayer cast film with a cyclic olefin polymer core layer and two outer layers used as polarizer protective films. The cyclic olefin polymer film (40 μm in thickness) had low moisture permeability of 0.32 g/100 in²/day at the conditions of 40° C. and 90% RH. Peel strength between the cyclic olefin polymer protective film and polarizer film significantly impacts the appearance and degree of polarization. The laminate film was not oriented.

U.S. Pat. No. 6,017,616 describes the method of making biaxially oriented cyclic olefin polymer films having a base layer and at least one outer layer. The cyclic olefin polymer film was made by coextrusion followed by orientation in the machine direction and transverse direction at stretching ratios of 2.0 and 3.2, respectively. The base layer of the film is made from a cyclic olefin polymer (COP) with a glass transition temperature Tg and the outer layer comprises at least two cyclic olefin polymers COP1 and COP2 with different glass transition temperatures Tg1 and Tg2, respectively, where Tg2−Tg1≧5° C. and Tg2−Tg≧5° C. The cyclic olefin polymer COP2 with higher Tg creates a rough surface during film orientation which can improve the processability of the film in the downstream of film production and avoid the disadvantages of voids and poor metal adhesion due to the use of inert particles such as SiO2, Al2O3 and silicates, etc. as anti-blocking agents in the outer layer.

U.S. Pat. No. 8,663,810 describes a method of making cast heat shrink films comprising cyclic olefin polymers in the skin layers by biaxial orientation processes. The resin of the core layer was selected from ethylene propylene copolymer, LLDPE and LDPE resin. The film can be solvent seamed and has an improved stiffness.

US Patent Publication 2014/0363600A1 describes a method of making non-oriented coextruded cast microlayered film with improved moisture vapor barrier properties. The microlayered film has 257 discrete layers and comprises high density polyethylene (HDPE) and cyclic olefin polymers (COP), including cyclic olefin copolymer (COC) and cyclic block copolymer (CBC), at the HDPE/COP ratio of 83/17 with a 33-nm microlayered COP layer. The MVTR of HDPE3 control film reached 0.13 g/100 in²/day (38° C./100% RH) thanks to its high density 0.97 g/cm³. The MVTRs of HDPE3, HDPE3/COC, and HDPE3/CBC1 are 0.13, 0.13 and 0.10 g/100 in²/day, respectively. The MVTR barrier improvement is about 0.23%, compared to the original MVTR of 0.13 g/100 in²/day for HPDE3. The microlayered HDPE3/COC film structure did not show MVTR improvement compared to the MVTR of HDPE3 film.

### SUMMARY OF THE INVENTION

Described herein is the incorporation of HCR additives into the core layer of a coextruded COC laminate film for improving processability and moisture vapor barrier and to maintain the optical properties of the COC laminate film. A desirable amount of HCR resins (Tg>60° C.) can not only lubricate the extrusion of the COC polymers pellets, but can increase the mobility of the chain segments of COC polymers for easier stretching in machine and transverse directions. HCR molecules can also occupy the nanovoids existing in the COC amorphous phase at the stage of heat-setting after orientation, leading to a reduction in the free volume of the core layer. Thus, by using a desirable amount of HCR additives, two mechanisms can be exploited to improve moisture vapor barrier properties.

The films disclosed herein also to seek an economical method to produce high performance biaxially oriented COC laminate films for applications requiring high moisture vapor barrier and stiffness. However, the cost of COC resins is much higher than the cost of high quality HCR resins. Thus, a significant cost reduction can be achieved by using high quality HCR resins in making COC films or articles as a processing aid. In addition, the COC films described herein can have two outer layers having high solvent resistance properties which can eliminate the disadvantage of the outer surface of a COC film. Furthermore, use of a processing aid may help improve the processability of high Tg COC polymers without internal microstructures for easier processing.

Efforts of investigating the applications of cyclic olefin copolymer (COC) films (or sheets) include the methods of adding COC resins into a polyolefin film structure as a minor component of shrink films or biaxially orienting COC sheet at low stretch ratios for applications in electronic industries as well as coextruding cast COC sheets (with two polyolefin outer layers) for blister packaging application as described in the arts. The super moisture vapor barrier and optical properties cyclic olefin copolymers can be found in the application in blister packaging.

Described herein are biaxially oriented transparent coextruded laminate sheets (films) having a cyclic olefin copolymer (COC) core layer and two outer skin layers. The coextruded COC laminate sheet (film) can comprise a core layer which provides high moisture vapor barrier properties and stiffness, and two outer layers which provide designed functionalities. The first outer layer can be formulated to have properties of solvent resistance, winding, adhesion, or printing. The second outer could be optionally formulated into a tie layer for inline or offline coating. In some embodiments, an outer coating layer can be for improving oxygen gas barrier properties or as a sealant layer for heat- or cold-sealing in downstream processes. The core layer of the coextruded laminate film can comprise cyclic olefin copolymers (COC) or optionally cyclo olefin polymers (COP), or blends thereof. Hydrogenated hydrocarbon resins (HCR) and linear low density polyethylene (LLDPE) can be optionally added into the core layer for improving processability and desirable properties required for certain applications; for instance, balancing toughness and stiffness. The content of HCR and LLDPE resins in the core layer can be in the range of 1 to 10 wt % and 5 to 20 wt % of the core layer, respectively. The outer layers can be formulated from polyolefins such as polypropylene (PP) and polyethylene (PE), copolymers or terpolymers of the monomers of ethylene, propylene, and butene, and maleic anhydride grafted/copolymerized polyolefins, cyclic olefin copolymers (COC), cyclic olefin polymers (COP), modified COC/COP polymers with polar groups, or blends thereof. In some embodiments, the disclosed films herein can be a monolayer film comprising the core layer.

Described herein are coextruded multilayer films comprising a core layer comprising at least 70 wt % cyclic olefin copolymer (COC), cyclo olefin polymer (COP), or blends thereof and 1-10 wt % hydrogenated hydrocarbon resin; and a polyolefin outer layer on a side of the core layer. The core layer can comprise 5-20 wt % linear low density polyethylene (LLDPE) and/or 100-1000 ppm fluoropolymer additive. The core layer can also comprise COC comprising copolymers of ethylene and norbornene. The hydrogenated hydrocarbon resin can be a fully hydrogenated water-white hydrocarbon resin. The films can be biaxially oriented including oriented 1.5-3.5 times in the machine direction (MD) and oriented 2-8 times in the transverse direction (TD). A stretch temperature (T_{MD}) in the machine direction can be in the range of Tg+10° C.≦T_{MD}≦(Tg+40° C.), wherein Tg is the glass transition temperature of the primary polymer of the core layer. A stretch temperature (T_{T}) in the transverse direction can be in the range of Tg≦T_{T}≦Tg+60° C., wherein Tg is the glass transition temperature of the primary polymer of the core layer. The polyolefin outer layer can comprise homopolymers, copolymers, terpolymers, maleic anhydride grafted or copolymerized polyolefins or blends thereof, cyclic olefin copolymers, cyclo olefin polymers, modified polar COC/COP polymers or blends thereof. In addition, the polyolefin outer layer can comprise antiblocking particles. In some embodiments, the polyolefin outer layer comprises ethylene containing homopolymer, copolymer, or terpolymer resins or blends thereof. The films can have a moisture vapor transmission rate of less than 0.16 g/100 in²/day. In addition, the films can have a haze value less than 15. Furthermore, the films can comprise a polar polymeric layer on a side of the polyolefin outer layer opposite the core layer. In some embodiments, the polyolefin outer layer is a heat sealable layer comprising sealant resin, wherein a Tg of the core layer is at least 20° C. higher than a Tm of the sealant resin. The films can have a total thickness of 5-100 μm. In addition, the stiffness of the films in the MD can be in the range of 0.5-15 mN-mm and the stiffness of the films in the TD can be in the range of 0.8-20 mN-mm.

Described herein are methods of making a biaxially oriented film comprising coextruding a film comprising a core layer comprising at least 70 wt % cyclic olefin copolymer (COC), cyclo olefin polymers (COP), or blends thereof and 1-10 wt % hydrogenated hydrocarbon resin; a first outer layer on a side of the core layer; and a second outer layer on a side of the core layer opposite the first outer layer and orienting the film, wherein the film is oriented 1.5-3.5 times in the machine direction and 2-8 times in the transverse direction. In addition, the methods can include heat setting the coextruded film. The core layer can comprise 5-20 wt % linear low density polyethylene (LLDPE) and/or 100-1000 ppm fluoropolymer additive. The core layer can also comprise COC comprising copolymers of ethylene and norbornene. The hydrogenated hydrocarbon resin can be a fully hydrogenated water-white hydrocarbon resin. A stretch temperature (T_{MD}) in the machine direction can be in the range of Tg+10° C.≦T_{MD}≦(Tg+40° C.), wherein Tg is the glass transition temperature of the primary polymer of the core layer. A stretch temperature (T_{T}) in the transverse direction can be in the range of Tg≦T_{T}≦Tg+60° C., wherein Tg is the glass transition temperature of the primary polymer of the core layer. One or both of the outer layers can comprise homopolymers, copolymers, terpolymers, maleic anhydride grafted or copolymerized polyolefins or blends thereof, cyclic olefin copolymers, cyclo olefin polymers, modified polar COC/COP polymers or blends thereof. In addition, at least one outer layer can comprise antiblocking particles. In some embodiments, the both outer layer comprise ethylene containing homopolymer, copolymer, or terpolymer resins or blends thereof. The film can have a moisture vapor transmission rate of less than 0.16 g/100 in²/day. In addition, the film can have a haze value less than 15. In some embodiments, at least one of the outer layers is a heat sealable layer comprising sealant resin, wherein a Tg of the core layer is at least 20° C. higher than a Tm of the sealant resin. The film can have a total thickness of 5-100 μm. In addition, the stiffness of the film in the MD can be in the range of 0.5-15 mN-mm and the stiffness of the films in the TD can be in the range of 0.8-20 mN-mm.

### DETAILED DESCRIPTION OF THE INVENTION

Described are tri-layer coextruded laminate films comprising a COC core layer to provide high moisture vapor barrier and stiffness as well as mechanical properties required for the film structure and two outer layers with designed functionalities with a film structure of A/B/C. The coextruded laminate film can be oriented either mono-axially or biaxially. Preferably, the laminate film is biaxially oriented in both the machine and transverse directions at the orientation ratios designed for the application of a laminate film.

The core layer of the laminate film can be a layer of cyclic olefin polymers (COC) or the blends of cyclic olefin copolymers and cyclic olefin polymers (COP). Hydrogenated hydrocarbon resins (HCR) and linear low density polyethylene (LLDPE) can be optionally added into the core layer to improve processability and film properties. The contents of the COC, COP, or blend of COC and COP can be at least 60 wt %, at least 70 wt. %, at least 75 wt. %, at least 80 wt. %, at least 85 wt. %, at least 90 wt. %, at least 95 wt. %, or at least 96 wt. % of the core layer.

The contents of HCR resins in the core layer can be from less than or equal to 40 wt %, less than or equal to 30 wt %, less than or equal to 25 wt %, less than or equal to 20 wt %, less than or equal to 15 wt %, less than or equal to 10 wt %, or less than or equal to 5 wt %. In some embodiments, the contents of HCR resins in the core layer can be in the range of 0-20 wt %, 1-15 wt %, or 2-10 wt %.

The contents of LLDPE resins in the core layer can be from less than or equal to 40 wt %, less than or equal to 30 wt %, less than or equal to 25 wt %, less than or equal to 20 wt %, less than or equal to 15 wt %, less than or equal to 10 wt %, or less than or equal to 5 wt %. In some embodiments, the contents of LLDPE resins in the core layer can be in the range of 0-30 wt %, 2-25 wt %, or 5-20 wt %.

In some embodiments, the contents of HCR and LLDPE resins in the core layer can be in the range of from 0-40 wt % or 0-20 wt %, respectively. If the contents of HCR and LLDPE are higher than 40 wt % in the core layer, the properties of the film may deteriorate.

The thickness of the films disclosed herein can be in the range of 5-100 μm or 10-50 μm.

A typical oriented PP or PE film modified with 10 to 20 wt % hydrogenated hydrocarbon resin can exhibit moisture transmission rates in the range of 0.18 to 0.24 g/100 in²/day which is about 1.5 to 2 times better than the moisture barrier properties of a non-HCR-modified BOPP film. Aside from the improvement in moisture barrier, hydrogenated hydrocarbon resin can improve the processability of high crystalline PP or PE resins.

Without being bound by any theory, it is believed that a low molecular weight HCR additive with a Tg lower than the stretch temperature of the COC/COP polymers can improve the processability of COC core layer. HCR additive in the core layer as a processing aid can apparently reduce the COC melt viscosity during extrusion so the extrusion output can be increased. The presence of a HCR additive can make the process of reorganizing the viscous COC polymer chains easier than without it.

Linear low density polyethylene (LLDPE) is compatibly with COC polymers in the prior arts. Adding 5 to 25 wt % LLDPE resin into the COC core layer can improve the toughness of a COC film as toughness may be required for the application of the final product. However, increasing the content of LLDPE in the core layer can negatively impact the moisture vapor barrier and optical properties.

A desirable amount of fluoropolymer additive in the range of from 100 to 20000 ppm, 100 to 10000 ppm, or 100 to 1000 ppm could be optionally added into the core layer to improve the extrusion and stretching of COC resins and help further enhance moisture barrier. In some embodiments, the amount of fluoropolymer additive in the core layer is 300-10000 ppm.

The first outer layer can be formulated to have properties of solvent resistance, winding, adhesion, or printing. The second outer layer can be optionally formulated into a tie layer (adhesion promoting layer) to coat a layer of polar polymer compositions for improving oxygen gas barrier or a sealant layer for heat- or cold-sealing in the downstream processes. The coating process can be conducted through inline or offline process. For an inline coating process, preferably, the coating process is in between the machine direction orienter (MDO) and transverse direction orienter (TDO).

The thickness of the outer layers can be from 0.5-10 μm or 0.5-4 μm. The weight percentage of the outer skin layers can be from 4-40 wt % of the total weight of the film. Each individual outer layer can be formulated to have functions of adhesion, lamination, or printing using polar polyolefin resins. The weight percentage of the polar polyolefin resins in the outer skin layer(s) can be from 5-100 wt % or 20-100 wt %.

The temperature of machine direction orientation can be set up in accordance with the stretch temperature of both the core resins (COC or COP glass transition temperature, Tg) and the resins of the skin layers (glass transition temperature, Tg or melting temperature of semi-crystalline polymers, Tm). It is preferred to set up the MDO temperature in the range of Tg+10° C.≦T≦(Tg+40° C.) or Tg+10° C.≦T≦Tm (as Tm>Tg+40° C.) for stretching and preventing the skin layers sticking onto MDO heating or stretching rolls. The stretch temperature (T) in the transverse direction can be set up in accordance with the glass transition temperature of the primary COC or COP core resin (Tg+40° C.) so that the clips in a tenter oven can hold the edges during the orientation. Preferably, the stretch temperature T is in the range of Tg≦T≦Tg+60° C., more preferably, in the range of Tg+20° C.≦T≦Tg+40° C. for TD orientation.

In one embodiment, the resultant COC laminate film could be a three-layer film (A/B/C) comprising two outer polymer layers (A and C), enclosing a core layer (B). The core layer can be sandwiched by two polar polymer layers, or two non-polar polymer layers, or one polar polymer layer and one non-polar polymer layer through coextrusion. The core layer of the laminate film can comprise a COC polymer, COP, or blend of COC and COP, including additives or blends thereof as described in the art. The two outer skin layers can be formulated as layers for the purposes of heat sealing, winding, adhesion, or printing, respectively. The outer layers could be formulated from polyolefins such as polypropylene (PP) and polyethylene (PE), copolymers or terpolymers of the monomers of ethylene, propylene, and butene, and maleic anhydride grafted/copolymerized polyolefins as well as additional slip or antiblock agents needed for the outer skin layers to control winding performance, and/or blends thereof.

In another embodiment, one of the two outer layers can be formulated into a tie layer to coat a coating layer for oxygen gas barrier or a sealant layer for heat- or cold-sealing applications in the downstream process through inline or offline coating processes. The coating layer can be a cross-linked product of polyvinyl alcohol/polyvinyl amine or PVOH or EVOH polar polymers and/or blends thereof.

In another embodiment, the outer layers of the coextruded COC laminate film can comprise COC or COP polymers. The COC or COP polymers in the outer layers can be either different from the polymer blends in the core layer or the same as that in the core layer. Additional slip or antiblock agents can be added into the outer skin layers for controlling winding performance or film handling. The COC laminate film can be made by coextrusion of the layers followed by stretching the laminate film in machine direction and then in transverse direction. The outer layers can be formulated into polar outer skin layer using functionalized COC or COP polymers or maleic anhydride (MAH)-grafted-LLDPE resins for the purpose of adhesion or printing. The content of the functionalized COC or COP or MAH-g-PE resins can be in the range of 2-100 wt % or 20-100 wt % of an outer layer. Polyolefin skin layers have much better solvent resistance compared to COC or COP skin layers.

In another embodiment, the coextruded COC laminate film can be a two-layer film (A/B film structure) comprising a COC core layer (B) and any outer skin layer (A) described above in the art. The outer skin layer can function as a layer to be formulated for the purpose of winding, adhesion, printing or solvent protection. The side of the core layer opposite to the skin layer can be corona discharge-treated to allow for higher surface energy for the suitability to receive coatings, inks, or to laminate to another substrate with adhesives.

In another embodiment, the coextruded COC laminate film could be either an oriented or a non-oriented coextruded laminate film. The desirable orientation ratios and casting speed depend on the application of the laminate film. High stretch ratios either in machine direction or transverse direction will lead to higher heat shrinkage in the direction of orientation at the temperature near and above the Tg of COC or COP polymers. Preferably, the stretch ratio in machine direction can be in the range of 1 to 4, more preferably, in the range of 1.2 to 3. The stretch ratio in the transverse direction can be in the range of 1 to 10, more preferably, in the range of 1.2 to 8. Preferably, a high Tg COC or COP polymer can be used to make a laminate film with a low heat shrinkage and high thermal stability, as well as heat-set to minimize thermal shrinkage.

In another embodiment, one of the outer layers or both outer layers of the coextruded COC laminate film can be formulated by using high density polyethylene (HDPE) to improve the stiffness and moisture vapor barrier of the laminate film. The thickness of the HDPE outer layers can be in the range of 0.5-20 μm or 0.5-4 μm. The weight percentage of HDPE outer skin layers can be 2-30 wt % of the total weight of the film. A small amount of LLDPE can be added into the outer skin layer to improve the bond strength between the skin layers and COC core layer. Preferably, the content of the LLDPE in the outer skin layer(s) can be in the range of 5-70 wt %, 5-30 wt %, or 5-20 wt. %. To stretch the laminate film in transverse direction, the Tg of COC core layer can be high enough so that the clips of the TDO can hold the edges of the laminate film web at the temperature to stretch HDPE skin layers. Preferably, the Tg of COC core layer can be in the range of 75 to 120° C., more preferably, in the range of 90 to 110° C., since it is well known that the Tm of HDPE (stretching temperature) is about 130° C. For orienting the laminate film in machine direction only, the temperature of MDO can be lower than the Tm of HDPE resin for preventing sticking onto MDO rolls. The resin of COC core layer can be selected in accordance with the guidance of stretching COC polymers described in the arts.

In another embodiment, the two outer layers of the coextruded COC laminate film can be formulated using a blend of homo-polypropylene and ethylene-propylene (EP) copolymer (or terpolymers containing the monomers of ethylene, butene, and propylene) and propylene-based elastomer resins. The content of the copolymer or terpolymer resins can be in the range of 5-100 wt % or 5-30 wt % of the layer for improving the bond strength between the outer skin layers and the core layers. Suitable copolymer and terpolymer resins include those containing 5 to 20 mol % monomers of ethylene and propylene. The temperature of MDO can match the temperatures for homo-PP orientation in machine direction. The temperature of TDO can be set at about the Tm of homo-PP resin (165° C.) for stretching the outer skin layers.

The most common cyclic olefin copolymers (COC) are the copolymer of ethylene and cyclic norbornene made by copolymerization using a transition metal catalyst. All COC polymers are completely amorphous and can be available from Topas Advanced Polymers under their Topas® tradename. An exception to completely amorphous nature of COC polymer is Topas® elastomer E-140, which comprise a high percentage of ethylene monomer (>80 mol %). The amorphous morphology of COC can be due to the steric hindrance created by the incorporation of norbornene in the polymer chains. Bulky norbornene has a rigid bridged-ring structure that prevents crystallization. The glass transition temperature (Tg) of the COC polymer can be controlled through varying the monomer ratio of ethylene and norbornene. The Tg of COC polymers in the present invention can be at least 60° C., more preferably, in the range of 70 to 150° C. Suitable COC polymers include but not limited to Topas® 8007, 6013, and 6015 grades with glass transition temperature of 78, 138 and 160° C., respectively. Semi-crystalline COC polymer Topas® elastomer E-140 (Tg≦−90° C. and Tm=84° C.) can also be used for modification to improve the ductility and toughness of the final product. The Topas® COC polymers are commercially available from Topas Advanced Polymers, Inc. Suitable COC polymers also include film grades of APEL™ cyclic olefin copolymer which are commercially available for Mitsui Chemical America, Inc. such as APL8008T, and APL6009T.

The Topas® 8007 F-600 has a melt flow rate of about 12 g/10 min. (230° C./2.16 Kg) and a glass transition temperature of 78° C. The resin also has very low water absorption 0.01% (at 23° C./saturated condition) and a very low water vapor permeability 0.85 g 100 μm/m²/day (38° C./90% RH).

Cyclo olefin polymers (COP) can be made by using only norbornene monomers through the technology of ring-opening metathesis polymerization and then hydrogenation. All of the repeating units of COP can be cyclic. Suitable COP polymers include but not limited to the grades of ZEONOR® 1020R and 1060R and grades of ZEONEX which are commercially available from ZEON Chemicals. Suitable COP polymers also include COP polymer grades of ARTON™ which are available from Japan Synthetic Rubber.

Hydrogenated hydrocarbon-based resins are commonly used in applications such as print inks, adhesives, polymer-modifiers and coatings. Typically, high quality hydrogenated hydrocarbon resins can be fully hydrogenated water-white amorphous materials having a softening point of from 90 to 150° C.; a glass transition temperature (Tg) in the range of from 50 to 90° C.; a weight-average molecular weight (Mw) in the range of from 500 to 2000 g/mole; and a polydispersity index (PDI) of 1.5 to 3.0, more preferably, 1.5 to 2.0 as determined using size exclusion chromatography (SEC). The hydrogenated hydrocarbon resins can be derived by thermally polymerizing olefins of aliphatic C5 feedstocks, aromatic C9 feedstocks, or a combination of C5/C9 feedstocks obtained from refinery industries, followed by a process of hydrogenation. Specific requirements for hydrogenated hydrocarbon resins in the present invention include the characteristics of high clarity, low color, color stability, low volatiles, and high thermal stability, which are the characteristics of hydrogenated hydrocarbon resins. Preferably, the COC/COP core layer of the inventive laminate film can comprise about 1 to 15 wt % of the hydrogenated hydrocarbon resins. More preferably, the content of the hydrogenated hydrocarbon resins is in the range of from 1-30 wt %, 1-25 wt %, 2-10 wt %, 3-10 wt %, 5-10 wt %, or 6-9 wt %. The glass transition temperature of the hydrogenated hydrocarbon resin can be a critical factor to the performance of modification. Preferably, the Tg of the hydrogenated hydrocarbon resins may not be 20° C. higher than the Tg of the primary COC/COP polymers in the core layer. More preferably, the Tg of the hydrogenated hydrocarbon resins may not be higher than the Tg of the primary COC polymers in the laminate film or the article. If the Tg of the hydrogenated hydrocarbon resins is higher than that of the primary COC/COP polymers, it can increase the stiffness of the final articles. This may not be desirable if the application requires high flexibility. Non-hydrogenated hydrocarbon resins have low thermal stability and high volatiles and therefore may not be suitable for the films disclosed herein. In some embodiments, the core layer is substantially free of non-hydrogenated hydrocarbon resins. In some embodiments, the film is substantially free of non-hydrogenated hydrocarbon resins.

Suitable grades of hydrogenated hydrocarbon resins include but are not limited to Eastotac™ H-130W, H-142W, Regalite™ R1125, and Plastolyn™ R1140 which are commercially supplied by Eastman Chemicals; Oppera™ PR100A which are commercially available from ExxonMobil; Arkon™ P-100, P-115, P-125, and P-140 hydrogenated hydrocarbon resins which are commercially available from Arakawa Chemicals; and Sukorez® SU-640 which is commercially available from Kolon Industries.

Regalite™ grade R1115 resin has a ring and ball softening point 123° C., a glass transition temperature (Tg) of about 70° C., a number average molecular weight (Mn) of 750 g/mol and a weight average molecular weight (Mw) of 1200 g/mol. Oppera™ PR100A resin has ring and ball softening point 137° C., a glass transition temperature (Tg) of about 86° C., a Mn of 850 g/mol and a Mw of 830 g/mol and a Mn of about 480 g/mol.

Generally, hydrogenated hydrocarbon resins are brittle thanks to their characteristics of low molecular weight. The hydrogenated hydrocarbon resins can be compounded into a masterbatch for better handling during coextrusion. Carrier resins and blending ratio depends on the basic properties of both carrier resins and hydrogenated hydrocarbon resins. In some embodiments, the hydrogenated hydrocarbon resins can be made into a 30 wt % masterbatch concentrate in Topas™ 8007 F-600 COC resin and 50 wt % masterbatch concentrate in homo-polypropylene Total Petrochemical's LX10903 resin.

The present disclosure demonstrates several embodiments and examples of the core layer of a typical BOPP film having added hydrogenated hydrocarbon and COC polymers. The polypropylene resins used can be highly isotactic semi-crystalline propylene homopolymers. Suitable examples of highly isotactic crystalline polypropylenes (HCPP) include LyondellBasell's HP2409, or Phillips 66's CH020XK, Total Petrochemical's LX10903 or 3270 grades. Typically, these HCPP resins have a melt flow rate in the range of from 1.5 to 3.5 g/10 min., a melting point in the range of from 160-167° C., and a density of about 0.90-0.92 g/cm³. Typical isotactic content of these high crystalline PP resins is above 95%. For instance, LX10903 HCPP is supplied by Total petrochemicals, the resin has a MFR of 2.0 g/10 min. and a melting temperature Tm of 165° C.

Polyethylene resins show compatibility with cyclic olefin copolymers (COC), especially, metallocene linear low density polyethylene (LLDPE). LLDPE has a density of from 0.910 g/cm³ to 0.940 g/cm³ (determining according to ASTM D1505) and comprises homogeneously branched short chains which make the polymers less crystalline and melt at a lower melting temperature range of from about 100 to 125° C. Examples of suitable LLDPE resins include but not limited to Exceed™ 4518PA with a melt flow rate of 4.5 g/10 min. (190° C./2.16 Kg) and a density of 0.918 g/cm³ which is a hexane copolymer supplied by ExxonMobil. Another example of suitable LLDPE could be Elite™5220 with a melt flow rate of 3.5 g/10 min. and a density of 0.915 g/cm³ which is commercially produced by Dow Chemical Company.

High density polyethylene (HDPE) can provide high performance in stiffness and moisture barrier properties. Suitable HDPE resins have a density in the range of 0.94 g/cm³ to 0.97 g/cm³ as determined by ASTM D792. The melt flow index of HDPE can be in the range of 0.25 to 20 g/10 min. as determined by ASTM D1238 (190° C./2.16 Kg conditions). Suitable examples of HDPE include but are not limited to high density polymers such as total HDPE 9260 and HPDE 9548. HDPE 9548 has a density 0.961 g/cm³ and melt flow index 1.2 g/10 min.; Total HDPE 9260 has a density of 0.960 g/cm³ and a melt flow index of 2.0 g/10 min., respectively.

The skin layers of the coextruded COC laminate film can be formulated from polar polyolefin layers for the application of coating and adhesion, or printing. The polyolefin resins can include ethylene homopolymer, propylene homopolymer, ethylene or propylene-based copolymers and terpolymers (e.g. ethylene-propylene, ethylene-butene, propylene-butene, ethylene-propylene-butene), or blends thereof. Modified polar polyolefin resins for instance as grafted polar polyolefins or copolymerized polar polyolefin resins can be added into the outer layers to promote adhesion, particularly as a tie-resin or tie-layer for receiving polar polymer coatings or coextruded layers. The weight percentage of the modified polar polyolefin resins in the outer layer(s) can be in the range from 5-100 wt % of the outer layer. A typical example of such a polar polymer may be obtained by grafting maleic anhydride functional groups onto the polyolefin backbone; or by copolymerizing the maleic anhydride functional group with the polyolefin monomers. Suitable examples of polar polymers include but are not limited to Lotader® grades such as Lotader® 3210 and Lotader® 3410; Polybond® grades such as Polybond® 3200 and Polybond®7200; Plexar® grades such as PP based Plexar®6000 Series, LLDPE based Plexar® 3000 series; HDPE based Plexar®2000 Series; and Mitsui Chemical Admer® PE or PP type grades.

In some embodiments, the COC laminate film comprises a first layer (A), a COC core layer (B), and a second skin layer (C). The first layer (A) and the second skin layer (C) can be coextruded onto the sides of the core layer (B); a typical configuration is to have the skin layers (A) and (C) on opposite sides of the core layer (B). In one embodiment, the layer A is formulated from a polar polymer which can be coated through inline or offline coating process. In this case, the first layer (A) is a tie-layer to the polar coating layer which provides the afore-mentioned high oxygen gas barrier property. The layer (A) can also comprise a “mini-random” ethylene-propylene copolymer (an EP copolymer with a fractional amount of ethylene content, e.g. less than 1 wt % ethylene co-monomer, preferably about 0.3-0.6 wt %) or maleic anhydride-grafted (MAH-g) polyolefins or blends thereof. A composition blended with a desirable amount of MAH-g-polypropylene can enhance the bond adhesion between the layer (A) and polar coatings or inks in comparison with the case of no added polar polymeric compatibilizer. The weight percentage of the polar polyolefin resins can be from 5-100 wt % or 20-100 wt % of the outer layer.

Suitable examples of the polymers for the outer skin layers include but are not limited to Total LX11203 mini-random polypropylene, Total 3576XHD homo-polypropylene, Lotader® 3210, and Admer® QF 500A. The weight percentage of non-polar polyolefin resins can be in the range of 0-95 wt % or 0-80 wt % of the outer layer. LX11203 is a mini-random polypropylene resin that has a melt flow rate of 3.5 g/10 min. (230° C./2.16 Kg) and a melting temperature 158° C., which is supplied by Total Petrochemicals. The ethylene content in the LX11203 is in the range of about 0.3-0.6 wt %. An amount of 600 ppm Silton® JC-30 antiblock particles was preloaded in the LX11203 resin by its supplier. Total 3576XHD homopolypropylene resin has a melt flow rate of about 8 g/10 min. (230° C./2.16 Kg) and a melting temperature Tm of about 160° C. An amount of about 5000 ppm Silton® JC-30 antiblock particles was preloaded into the resin by supplier. Lotader® 3210 is a random terpolymer of ethylene, butyl acrylate and maleic anhydride, which is supplied by Arkema Inc. The resin has melt flow rate of about 5 g/10 min. (190° C./2.16 Kg), a melting temperature of about 107° C., a maleic anhydride content of 3.1 wt %, and a butyl acrylate content of 6 wt %. Admer® QF500A is a maleic anhydride grafted polypropylene MAH-g-PP, which is commercially supplied by Mitsui Chemicals. The resin has a melt flow rate of about 3.0 g/10 min. at 230° C./2.16 Kg and a density of 0.90 g/cc, and a maleic anhydride content of about 0.8 wt %.

If the coextruded COC film is designed for heat-sealable application, the heat-sealable layer can be any polyolefin that has a melting point lower than the Tg of COC or COP polymers in the core layer such as Topas™ 6015 cyclic olefin copolymer. The Tg of the core layer can be at least 10° C. higher than the Tm of the skin resins. Typically, the Tm of the heat sealable skin resins can be in the range of 60 to 145° C. Suitable polymers for the skin resins can be copolymers or terpolymers of propylene, ethylene and butene, and blends thereof, but preferably can be a copolymer of propylene, either ethylene-propylene or butylene-propylene, and preferably comprises a ternary ethylene-propylene-butene copolymer, or blends thereof. The weight percentage of an individual component in the heat sealable layer(s) can vary with the requirements for seal initiation temperature (SIT), seal temperature range, and seal strength for a specific product. Examples of suitable heat-sealable terpolymer resin include Sumitomo SPX78R6 and WF345J2 which have a melt flow rate of about 8 g/10 min. (230° C./2.16 Kg) and a melting temperature of about 132° C. Examples of suitable heat-sealable ethylene-propylene copolymers include Total 8573 with a melt flow rate of about 8 g/10 min. (230° C./2.16 Kg) or ExxonMobil Vistamaxx™ 3980FL with a melt flow rate of about 9 g/10 min. (230° C./2.16 kg) and a melting temperature of about 77° C. These heat-sealable resins may also incorporate optional amounts of antiblock and slip additives for control of coefficient of friction and film handling needs.

The core layer (B) can comprise a COC polymer blended with an amount of a hydrogenated hydrocarbon resin, LLDPE, and a fluoropolymer additive. One side of the core layer can be contiguously attached the first layer (A) and the other side can be contiguously attached to the second skin layer (C) with functionalities of adhesion and winding, etc. as desired. The outer layers can comprise a blend of ethylene-containing copolymer or terpolymer resins to enhance the bond strength between the COC core and the outer skin layers. The weight percentage of the ethylene-containing polymer resins can be in the range of 2-100 wt % or 10-100 wt % of the outer layer. The ethylene segments inside the ethylene-containing polymers can provide compatibility and entanglements at molecular levels required for bond strength at the interface between the COC core layer and the outer skin layers.

An optional but desirable amount of fluoropolymer additive can be included in the core layer to improve the extrusion dispersion of HCR or LLDPE in the core layer. In some embodiments, the content of the fluoropolymer additive can be in the range of about 100-20000 ppm, 200-10000 ppm, 100-1000 ppm, or 300-600 ppm of the core layer. This fluoropolymer is typically available as a processing aid in a masterbatch form and is typically polymerized from two monomers—hexafluoropropylene and vinylidene fluoride—to form a poly(vinylidene) fluoride-co-hexafluoropropylene polymer (1,1-difluoroethylene-1,1,2,3,3,3-hexafluoro-1-propene copolymer). This fluoropolymer typically has a weight average molecular weight M_{w} of about 400,000 to 455,000 g/mol; a number average Mₙ of about 110,000 to 130,000 g/mol; a melting point of about 135-140° C.; melt flow rate of about 4-10 g/10 min. at 230° C. A suitable fluoropolymer masterbatch can be Ampacet 10919-P supplied by Ampacet Corporation. The masterbatch has 3 wt % of fluoropolymer in a LLDPE carrier resin. These masterbatches typically have a density of about 0.90-0.92 g/cm³ and a melt flow rate of 1-12 g/min. at 190° C./2.16 Kg.

There may be a need to add inorganic or organic anti-blocking agents into the outermost skin layers to improve processability in film-making and handling. A desirable amount of anti-blocking agents may be added up to 10,000 ppm to these outer layers, depending on their functionality, preferably 100-10000 ppm, 200-5000 ppm, or 300-5000 ppm of anti-blocking agents may be added. Suitable inorganic anti-blocking agents include those such as inorganic silicas and sodium calcium aluminosilicates. Suitable organic anti-blocking agents include those such as cross-linked spheres of polymethylsilsesquioxane and polymethylmethacrylate. Typically, useful particle sizes of these anti-blocking agents are in the range of from 0.2-7 μm, preferably in the range of from 2-5 μm. Other suitable additives may also include migratory slip agents. Examples of those include fatty amides and silicone oils of low molecular weight molecules, and/or combinations thereof. Examples of—but not exclusive of—fatty amides are stearamide, erucamide, behenamide, and/or combinations thereof.

For a typical 3-layer coextruded COC film embodiment as described previously, the coextrusion process can include a three-layered compositing die. The polymeric COC core layer (B) can be sandwiched between the skin layer (A) and the heat-sealable or winding layer (C). The outer layer (A) of three layer COC laminate sheet can be cast onto a chill or casting drum with a controlled temperature in the range of from ca. 30 to 45° C. to solidify the non-oriented laminate sheet, followed by a secondary cooling on another chill drum with a controlled temperature. The non-oriented laminate sheet can then be stretched in the machine direction at about 75 to 100° C. at a ratio of about 2 to 3.5 times of the original length and then heat set at about 70° C. to obtain a uniaxially oriented laminate sheet with minimal thermal shrinkage. The uniaxially oriented COC laminate sheet can be introduced into a tenter and preliminarily heated between about 75° C. and 120° C., and stretched in the transverse direction at a ratio of about 6 to 8 times of the original length and then heat-set and subjected to about 5 to 10% relaxation in the tenter frame to give a biaxially oriented COC sheet with minimal thermal shrinkage.

The films disclosed herein will be better understood with reference to the following examples, which are intended to illustrate specific embodiments within the overall scope of the disclosure.

### Example 1

Example 1 represents an embodiment to describe the experimental conditions of making the same. A 3-layer coextruded COC laminate film was made on a nominal 1.6 m wide biaxial orientation line, comprising of a core layer (B), a skin layer (A) on one side of the core layer, and a skin layer (C) on the other side of the core layer opposite that of the skin layer (A). The core layer comprised of about 100 wt % Topas™ 8007 F-600 cyclic olefin copolymer (COC) resin. The skin layer (A) comprised of about 78 wt % Exceed® 4518PA metallocene LLDPE supplied by ExxonMobil Chemical Corporation and about 20 wt % Lotader® 3210 random terpolymer of ethylene, acrylic ester and maleic anhydride and about 2 wt % RLLJ30 antiblock masterbatch compounded from Silton® JC-30 antiblocks and Exceed® 4518PA LLDPE with a blend ratio of 5/95. Silton® JC 30 is an anti-blocking agent with nominal 3 μm particle size of a spherical sodium calcium aluminum silicate manufactured by Mizusawa Industrial Chemicals, Co., Ltd. The skin layer (C) comprised of about 98 wt % Exceed® 4518PA metallocene LLDPE and about 2 wt % RLLJ30. The recipes of satellite extruders for layers (A) and (C) are shown in Table 1 (A1 and C1) and the recipe of main extruder for layer (B) is shown in Table 2.

The total thickness of this 3-layer coextruded film substrate after biaxial orientation was nominal 100 G (25 μm). The thickness of the skin layer (A) and skin layer (C) after biaxial orientation was nominal 4 G (1 μm). The thickness of the COC core layer (B) was nominal 92 G (23 μm). The skin layer (A) and (C) were melt-extruded at about 230-240° C. The core layer (C) was melt-extruded at 240-260° C. The 3-layer coextrudate was passed through a flat die to be cast on a chill drum of about 40-50° C. The formed cast sheet was passed through a series of heated rolls at about 90-110° C. with differential speeds to stretch in the machine direction (MD) to a 3.0 stretch ratio. This was followed by transverse direction (TD) stretching to an 8.0 stretch ratio in the tenter oven at about 90-110° C. Inside the tenter oven, there are three zones for the purposes of heating, stretching and heat setting. The temperatures of first, second and third zones are ca. 110, 105 and 95° C., respectively. After transverse stretching, the film was heat-set in the third zone to minimize thermal shrinkage, followed by a 5% to 7.5% relaxation in the transverse direction. The resultant laminate film was corona-discharge treated upon the surface of the two outer layers before it was wound into a roll form. The film was then tested for appearance, optical properties, moisture vapor barrier, and mechanical properties. The film was also forced-heat-aged by placing it in a conditioning oven at an elevated temperature of about 50° C. for 12 hrs in order to further relax and reduce the free volume in the core layer.

The three layer COC laminate film was tested for film thickness, bending stiffness, tensile strength, elongation at break, haze and moisture vapor barrier as shown in Table 3. The nominal thickness of each layer was controlled by the output of extruders (rpm) and determined using the cross-session image obtained by SEM. All of barrier data in Table 3 were obtained by averaging the two barrier data values collected from two cells of a Mocon Permatran® 3/31 moisture vapor transmission rate (MVTR) test module at nominal 38° C. and 90% relative humidity (RH). The sample had a moisture vapor transmission rate of about 0.161 g/100 in²/day. Aging process was set at temperature 50° C. and duration time about 12 hrs; after aging, the MVTR of the COC laminate film sample was slightly reduced to about 0.156 g/100 in²/day. Aging the film sample did not significantly improve the moisture vapor barrier. The properties of Ex1 will be used as a control to compare with the properties of other inventive COC laminate films.

### Examples 2-5

Examples 2-5 were made using the same conditions as that of Example 1. The recipes of satellite extruders are still A1 and C1 for layer (A) and layer (C), respectively. Hydrogenated hydrocarbon resins Regalite™ R1125 and Oppera™ PR100A (made into a 30 wt % masterbatch in COC carrier resin) as processing aid were incorporated into the COC core layer to improve processability and properties of the coextruded COC laminate films. Hydrogenated hydrocarbon resin Regalite™ R1125 was added into the core layer at a neat HCR loading of 6 wt % and 9 wt % in Example 2 and Example 3, respectively. In Example 4 and Example 5, hydrogenated hydrocarbon resin Oppera™ PR100A was incorporated into the core layer at the neat HCR loading levels of 6 wt % and 9 wt %, respectively. The recipes of Examples 2-5 were listed in Table 1 and 2. Regalite™ R1125 and Oppera™ PR100A were compounded into 30 wt % masterbatch with Topas® 8007 F-600 at a ratio of 30/70, respectively, for easily being fed into the hopper of an extruder.

Ex2 in Table 3 indicates that adding 6 wt % Regalite R1125 HCR into the core layer of COC laminate film does not impact the bending stiffness and haze of the film. The elongation at break in MD direction reduced from 141% to 93% while the elongation at break did not change in TD direction. The moisture vapor transmission rate decreased slightly for both the unaged sample and the heat-force-aged sample. As the loading of Regalite™ R1125 in the COC core layer was increased to 9 wt %, the elongation at break reduced further to 4% from 94% in MD direction. The bending stiffness increased with increasing HCR loading. There is no change in haze of the COC laminate film. The tensile strength of the COC laminate film (Ex1) decreased as 6 wt % Regalite™ R1125 was added into the core layer. The MVTR of COC laminate film (Ex3) increased slightly; higher HCR loading did not further reduce the MVTR of the COC laminate film. Similar trend in the change of elongation at break was observed for the COC laminate film samples made with 6 wt % and 9 wt % Oppera™ PR100A in the COC core layer, but Oppera™ PR100A reduced the bending stiffness of the laminate film. Unlike Regalite™ R1125 in the same loading range, the PR100A HCR did not impact the haze of the laminate film (as shown in Ex2, Ex3 and Ex7). However, Oppera™ PR100A in the core layer significantly increased the haze of the COC laminate film (Ex4 and Ex5).

### Examples 6-7

Examples 6-7 were made using the same conditions as that of Example 1. For Example 6, the composition of the core layer (B) was 100 wt % Topas® 8007 F-600 cyclic olefin copolymer, while for Example 7, Regalite™ R1125 was added into the core layer at a level of 6 wt % (Table 2). The recipes of satellite extruders were changed to A2 and C2, respectively. The recipe A2 of satellite extrude for layer (A) comprised of about 75 wt % WF345J2, 20 wt % Lotader® 3210, and 5 wt % ExxonMobil Vistamaxx™ 3980FL ethylene-propylene plastomer. The recipe C2 of satellite extruder for layer (C) comprised of 95 wt % WF345J2 and 5 wt % Vistamaxx™ 3980FL (Table 1). WF345J2 is a terpolymer of ethylene-propylene-butene supplied by Sumitomo which also contains a preloaded antiblock agent at a level of about 4000 ppm of a nominal 2 μm particle size of a spherical cross-linked silicone polymer (Momentive Performance Materials' Tospearl® 120). WF345J2 resin has a melt flow rate of 8 g/10 min. measured under conditions of 230° C./2.16 Kg and a melting temperature of about 132° C. ExxonMobil Vistamaxx™ 3980FL is a copolymer of ethylene and propylene which has a melt flow rate of about 8 g/10 min. measured under conditions of 230° C./2.16 Kg and a melting temperature of about 77° C.

In Examples 6 and 7, the outer skin layers contained propylene-based terpolymer and copolymer resins. Ethylene segments in the molecular molecules of those resins in the outer skin layers created bond strength to the core layer through physical entanglements at the interface between the core and the skin layers. Without adding HCR into the core layer, the bending stiffness was comparable to that of Ex1 with LLDPE skin layers while the tensile strength of the COC laminate films decreased significantly. After adding about 6 wt % Regalite™ R1125 HCR resin into the core layer, the MVTR increased by 16% from 0.160 to 0.186 g/100 in²/day. The process of heat aging the samples at 50° C. for 12 hrs surprisingly increased the MVTR of the laminate film samples.

Regalite™ R1125 hydrogenated hydrocarbon resin at the loading levels of 6 to 9 wt % in the core layer did not increase the haze of the COC laminate film, while Oppera™ PR100A in the COC laminate layer made the COC laminate film hazier than the control film (Ex1). It is not desirable for a number of applications as the haze of a film increases to surpass a specification for transparency of the film. In addition, without changing extrusion temperature and screw speed (rpm), the motor torques observed for Ex1, Ex2 and Ex3 are 41%, 36% and 34%, respectively. It is noted that the motor torque of extrusion was reduced with increasing loading of Regalite™ R1125 resin in the range of from 0 to 6 wt %, to 9 wt % in the COC core layer. Energy saving and higher extrusion output can be achieved through using hydrogenated hydrocarbon resin processing aid such as Regalite™ R1125.

### Comparative Example 1

Comparative Example 1 (CEx1) was made using the same conditions as that of Examples 6-7. There was no change applied to the recipes of satellite extruders (Table 1 and 2). The composition of the core layer (B) was changed to a blend of about 80 wt % Total HDPE 9260 resin and 20 wt % Topas® 8007 F-600, CEx1 did not contain hydrogenated hydrocarbon resin additive (as shown in Table 2).

The resultant coextruded laminate film with added Topas® 8007 F-600 in the core layer demonstrated high haze compared to the control COC film Ex1 probably contributed by HDPE 9260 resin in the core layer. The laminate film sample also showed much lower bending stiffness. The MVTR of the laminate film was 0.171 g/100 in2/day, which is higher than the MVTR of the COC control film shown in Ex1.

### Comparative Examples 2-5

A process similar to that used in Example 1 but BOPP conditions applied to the process was repeated to make the nominal 80 G (20 μm) resultant laminate films (CEx2, CEx3, CEx4, and CEx5). A 3-layer coextruded film was made on the same setup and pilot line as Example 1. The total thickness of this 3-layer coextruded film substrate after biaxial orientation was nominal 80 G (20 μm). The thickness of the skin layer (A) and sealant skin layer (C) after biaxial orientation was nominal 4 G (1 μm) and 4 G (1 μm), respectively. The thickness of the core layer (B) is nominal 72 G (18 μm). The recipe A3 of satellite extruder for layer (A) comprises of about 50 wt % Total LX11203 and 50 wt % Admer® QF 500A. The Admer® QF500A is a maleic anhydride grafted polypropylene MAH-g-PP supplied by Mitsui Chemical Corporation. LX11203 is a mini-random polypropylene resin having a melt flow rate of 3.5 g/10 min. (230° C./2.16 Kg) and a melting temperature 158° C. The ethylene content is in the range of about 0.3-0.6 wt %. The mini-random polypropylene LX11203 resin contains preloaded 600 ppm Silton® JC-30 antiblock particles. LX11203 is supplied by Total Petrochemicals. The recipe C3 of satellite extruder for layer (C) comprised 100 wt % Total 3576XHD homopolypropylene resin. Total 3576XHD resin contains preloaded 5000 ppm Silton® JC-30 antiblock particles and is supplied by Total Petrochemicals. The melt flow rate of 3576XHD is about 8 g/10 min. (230° C./2.16 Kg) and the melting temperature Tm of the homo-PP resin is about 160° C.

All three layers (A), (B) and (C) were melt-extruded at about 230-260° C. The 3-layer coextrudate was passed through a flat die to be cast on a chill drum of about 20-26° C. The formed cast sheet was passed through a series of heated rolls at about 100-124° C. with differential speeds to stretch in the machine direction (MD) to a 4.75 stretch ratio. This was followed by transverse direction (TD) stretching to an 8.0 stretch ratio in the tenter oven at about 150-170° C. in a tenter oven. Inside the tenter oven, there are three zones for the purposes of heating, stretching and heat setting. The temperatures of first, second and third zones are ca. 165, 155 and 150° C., respectively. After transverse stretching, the film was heat-set in the third zone to minimize thermal shrinkage, followed by a 5% relax in the transverse direction. The resultant laminate film was corona-discharge treated upon the surface of the outer layer opposite the outer skin layer (C) before it was wound into a roll form.

Comparative Example 2 (CEx2) was made with a core layer comprising of 100 wt % Total LX10903 high crystalline polypropylene resin. The laminate film showed much lower bending stiffness in both MD and TD but much higher tensile strength compared to the COC laminate film (Ex1). The MVTR of this typical BOPP film is about two times higher than the COC laminate film.

The core layer of Comparative Example 3 comprised of 70 wt % Total LX10903 HCPP, 20 wt % Topas® 8007 F-600, and 10 wt % Vistamaxx™ 3980FL. Vistamaxx™ 3980FL was used as a compatibilizer between the COC and HCPP resin in the core layer. The Topas® 8007 F-600 COC polymer in the core layer significantly reduced the MVTR of the laminate film from resin. The COC polymer did not increase the haze of the laminate film. The bending stiffness of the laminate film was increased after the COC polymer was added in the core layer.

Comparative Examples 4 and 5 demonstrated the influence of a combination of hydrogenated hydrocarbon resin Oppera™ PR100A and Topas® 8007 F-600 COC in the core layer on the moisture vapor barrier property. The addition of hydrogenated hydrocarbon resin Oppera™ PR100A in the core layer did reduce the MVTR of the laminate film at the content of 12.5 wt %, while the content was increased to 17.5 wt %, the MVTR of the laminate film was reduced to 0.168 g/100 in²/day from 0.225 g/100 in²/day. The MVTR of a BOPP laminate film with 10 wt % Oppera™ PR100A was in the range of 0.17 to 0.24 g/100 in²/day as reported in the prior arts.

TABLE 1

| | | Resins used in the satellite extruders: outer layers | | | | | | | |
|---|---|---|---|---|---|---|---|---|---|
| | | Exeed | Lotader | | | Vistamaxx | Total | Admer | Total |
| Satellite extrude | Recipe | 4518PA | 3210 | RLLJ30 | WF345J2 | 3980FL | LX11203 | QF500A | 3576XHD |
| Extruder A | A1 | 78 | 20 | 2 | | | | | |
| | A2 | | 20 | | 75 | 5 | | | |
| | A3 | | | | | | 50 | 50 | |
| Extruder C | C1 | 98 | | 2 | | | | | |
| | C2 | | | | 95 | 5 | | | |
| | C3 | | | | | | | | 100 |

The numbers in Table 1 are weight percent based on the total weight of the layer.

TABLE 2

| | | Extruder B: Resins used in core layer | | | | | | | |
|---|---|---|---|---|---|---|---|---|---|
| | Extrader A | Topas 8007 | Regalite | OPPERA | Exeed | Total | Total | Vistamaxx | Extruder C |
| Examples | recipe | F-600 | R1125 | PR100A | 4518PA | 9260 | LX10903 | 3980FL | recipe |
| Ex1 | A1 | 100 | | | | | | | C1 |
| Ex2 | A1 | 94 | 6 | | | | | | C1 |
| Ex3 | A1 | 91 | 9 | | | | | | C1 |
| Ex4 | A1 | 94 | | 6 | | | | | C1 |
| Ex5 | A1 | 91 | | 9 | | | | | C1 |
| Ex6 | A2 | 100 | | | | | | | C2 |
| Ex7 | A2 | 94 | 6 | | | | | | C2 |
| CEx1 | A2 | 20 | | | | 80 | | | C2 |
| CEx2 | A3 | | | | | | 100 | | C3 |
| CEx3 | A3 | 20 | | | | | 70 | 10 | C3 |
| CEx4 | A3 | 20 | | 12.5 | | | 57.5 | 10 | C3 |
| CEx5 | A3 | 20 | | 17.5 | | | 52.5 | 10 | C3 |

The numbers in Table 1 are weight percent based on the total weight of the layer.

TABLE 3

| | Layer | | | Stiffness | | | | Elongation | | | MVTR | |
|---|---|---|---|---|---|---|---|---|---|---|---|---|
| | thickness | | | (mN- | | Tensile | | at | | | (g/100 in²/day) | |
| | (μm) | | | mm) | | strength (psi) | | break (%) | | MVTR | aged at | Haze |
| Examples | A | B | C | MD | TD | MD | TD | MD | TD | (g/100 in²/day) | 50° C./12 hrs | (%) |
| Ex1 | 1 | 23 | 1 | 2.7 | 3.2 | 10610 | 26037 | 141 | 28 | 0.161 | 0.156 | 6 |
| Ex2 | 1 | 23 | 1 | 2.7 | 3.2 | 8017 | 18920 | 93 | 28 | 0.156 | 0.149 | 6 |
| Ex3 | 1 | 23 | 1 | 2.8 | 3.5 | 7541 | 16320 | 4 | 26 | 0.166 | 0.161 | 6 |
| Ex4 | 1 | 23 | 1 | 2.0 | 2.6 | 7391 | 21807 | 119 | 50 | 0.171 | 0.157 | 12 |
| Ex5 | 1 | 23 | 1 | 2.6 | 2.6 | 6419 | 23630 | 40 | 55 | 0.157 | 0.152 | 11 |
| Ex6 | 1 | 23 | 1 | 2.5 | 3.2 | 6203 | 12313 | 19 | 79 | 0.160 | 0.170 | 6 |
| Ex7 | 1 | 23 | 1 | 2.0 | 2.7 | 8223 | 12233 | 4 | 56 | 0.186 | 0.210 | 6 |
| CEx1 | 1 | 23 | 1 | 1.5 | 2.0 | 16390 | 20863 | 278 | 28 | 0.171 | 0.212 | 19 |
| CEx2 | 1 | 18 | 1 | 0.8 | 1.3 | 19814 | 44225 | 211 | 30 | 0.325 | 0.311 | 6 |
| CEx3 | 1 | 18 | 1 | 1.2 | 2.2 | 23170 | 32577 | 192 | 49 | 0.225 | 0.214 | 6 |
| CEx4 | 1 | 18 | 1 | 1.3 | 2.2 | 20783 | 26680 | 195 | 51 | 0.234 | 0.184 | 5 |
| CEx5 | 1 | 18 | 1 | 1.1 | 2.1 | 18853 | 22437 | 172 | 46 | 0.168 | 0.219 | 5 |

### Test Methods

The various properties in the above examples were measured by the following methods:

Moisture vapor transmission rate (MVTR) of the films was measured by using a Mocon Permatran® 3/31 unit measured substantially in accordance with ASTM F1249. In general, the preferred value can have average value equal to or less than about 0.17 g/100 in²/day (2.64 g/m²/day).

Forced heat-aging of the test films was conducted as follows: several 8½″×11″ cut-sheet samples of the exemplary films (e.g. about a dozen sheets of one of the respective film variables) were stacked or cut from a slab sample with the corona discharge-treated surface of the cut-sheet film samples facing in the “up” position. This stack of film samples were then placed between two smooth, flat steel plates (ordinary office printer paper was placed over the top film sheet sample and on top of the bottom steel plate to separate the film samples from direct contact with the steel plates, the weight of the steel plate is about 2 lbs/each), and this construction was then placed inside a conditioning oven. No extra load was applied to the top of steel plate. The conditioning oven was set for about 50° C. for 12 hours. After aging, the stack of film samples was removed and allowed to cool to room temperature. The upper steel plate was removed, and the office paper and the first sheet of the film sample stack were discarded. The remaining film sheet samples were carefully separated for moisture vapor transmission rate test.

Haze of the film was measured using a BYK Gardner Instruments “Haze-Gard Plus” haze meter substantially in accordance with ASTM D1003. Generally, light transmission percentages over 85 (or haze values lower than 15) are considered to be “transparent” or “clear”. The haze of the films disclosed herein can be less than 15. The perceived transparency or optical clarity can be dependent on thickness of the sample, and optical clarity will decrease with increased thickness.

Stiffness (i.e., specific bending stiffness) was tested by using TMI Bending Resistance Tester (Model K416) produced by Testing Machine Inc. The width of test film sample is B=38.0 mm, bending length is L=5.0 mm, and bending angle is p=15.0°. The film sample is bent to 15.0° angle and bending load F in milli-Newtons is displayed and recorded. Specific bending stiffness can be calculated from using the equation of Specific Stiffness (mN-mm)=60*F*L²/π*β*B. The stiffness of the film in the MD can be in the range of 0.5-15, 1-5, or 2-3 mN-mm and the stiffness of the film in the TD can be in the range of 0.8-20, 1-10, 2-5, or 2.5-3.5 mN-mm.

Tensile strength and elongation percent at break of the film were determined according to ASTM D882 using an Instron tensile tester. The average number for machine direction and transverse direction is used.

This application discloses several numerical ranges. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A coextruded multilayer film comprising:
a core layer comprising at least 70 wt % cyclic olefin copolymer (COC), cyclo olefin polymer (COP), or blends thereof and 1-10 wt % hydrogenated hydrocarbon resin;
a polyolefin outer layer on a side of the core layer.

2. The coextruded multilayer film of claim 1, wherein the core layer comprises 5-20 wt % linear low density polyethylene (LLDPE).

3. The coextruded multilayer film of claim 1, wherein the core layer comprises 100-1000 ppm fluoropolymer additive.

4. The coextruded multilayer film of claim 1, wherein the core layer comprises COC comprising copolymers of ethylene and norbornene.

5. The coextruded multilayer film of claim 1, wherein the hydrogenated hydrocarbon resin is a fully hydrogenated water-white hydrocarbon resin.

6. The coextruded multilayer film of claim 1, wherein the film is biaxially oriented.

7. The coextruded multilayer film of claim 6, wherein the film is oriented 1.5-3.5 times in the machine direction and oriented 2-8 times in the transverse direction.

8. The coextruded multilayer film of claim 7, wherein a stretch temperature (T_{MD}) in the machine direction (MD) is in the range of Tg+10° C.≦T_{MD}≦(Tg+40° C.), wherein Tg is the glass transition temperature of the primary polymer of the core layer.

9. The coextruded multilayer film of claim 7, wherein a stretch temperature (T_{T}) in the transverse direction (TD) is in the range of Tg≦T_{T}≦Tg+60° C., wherein Tg is the glass transition temperature of the primary polymer of the core layer.

10. The coextruded multilayer film of claim 1, wherein the polyolefin outer layer comprises homopolymers, copolymers, terpolymers, maleic anhydride grafted or copolymerized polyolefins or blends thereof, cyclic olefin copolymers, cyclo olefin polymers, modified polar COC/COP polymers or blends thereof.

11. The coextruded multilayer film of claim 9, wherein the polyolefin outer layer comprises antiblocking agents.

12. The coextruded multilayer film of claim 9, wherein the polyolefin outer layer comprises ethylene containing homopolymer, copolymer or terpolymer resins or blends thereof.

13. The coextruded multilayer film of claim 1, wherein the film has a moisture vapor transmission rate of less than 0.16 g/100 in²/day.

14. The coextruded multilayer film of claim 1, wherein the film has a haze less than 15.

15. The coextruded multilayer film of claim 1, further comprising a polar polymeric layer on a side of the polyolefin outer layer opposite the core layer.

16. The coextruded multilayer film of claim 1, wherein the polyolefin outer layer is a heat sealable layer comprising sealant resin, wherein a Tg of the core layer is at least 20° C. higher than a Tm of the sealant resin.

17. The coextruded multilayer film of claim 1, wherein the film has a total thickness of 5 to 100 μm.

18. The coextruded multilayer film of claim 1, wherein the stiffness of the film in the MD is 0.5-15 mN-mm and the stiffness of the film in the TD is 0.8-20 mN-mm.

19. A method of making a biaxially oriented film comprising:
coextruding a film comprising a core layer comprising at least 70 wt % cyclic olefin copolymer (COC), cyclo olefin polymers (COP), or blends thereof and 1-10 wt % hydrogenated hydrocarbon resin; a first outer layer on a side of the core layer; and a second outer layer on a side of the core layer opposite the first outer layer;
orienting the film, wherein the film is oriented 1.5-3.5 times in the machine direction and 2-8 times in the transverse direction.

20. The method of claim 19, further comprising heat setting the coextruded film.

21. The method of claim 19, wherein the core layer comprises 5-20 wt % linear low density polyethylene (LLDPE).

22. The method of claim 19, wherein the core layer comprises 100-1000 ppm fluoropolymer additive.

23. The method of claim 19, wherein the core layer comprises COC comprising copolymers of ethylene and norbornene.

24. The method of claim 19, wherein the hydrogenated hydrocarbon resin is a fully hydrogenated water-white hydrocarbon resin.

25. The method of claim 19, wherein a stretch temperature (T_{MD}) in the machine direction (MD) is in the range of Tg+10° C.≦T_{MD}≦(Tg+40° C.), wherein Tg is the glass transition temperature of the primary polymer of the core layer.

26. The method of claim 19, wherein a stretch temperature (T_{T}) in the transverse direction (TD) is in the range of Tg≦T_{T}≦Tg+60° C., wherein Tg is the glass transition temperature of the primary polymer of the core layer.

27. The method of claim 19, wherein the first and second outer layer comprise homopolymers, copolymers, terpolymers, maleic anhydride grafted or copolymerized polyolefins or blends thereof, cyclic olefin copolymers, cyclo olefin polymers, modified polar COC/COP polymers or blends thereof.

28. The method of claim 27, wherein at least one of the first and second outer layer comprises antiblocking agents.

29. The method of claim 19, wherein the first and second outer layer comprise ethylene containing homopolymer, copolymer or terpolymer resins or blends thereof.

30. The method of claim 19, wherein the film has a moisture vapor transmission rate of less than 0.16 g/100 in²/day.

31. The method of claim 19, wherein the film has a haze less than 15.

32. The method of claim 19, wherein the first outer layer is a heat sealable layer comprising sealant resin, wherein a Tg of the core layer is at least 20° C. higher than a Tm of the sealant resin.

33. The method of claim 19, wherein the film has a total thickness of 5 to 100 μm.

34. The method of claim 19, wherein the stiffness of the film in the MD is 0.5-15 mN-mm and the stiffness of the film in the TD is 0.8-20 mN-mm.
